(19) United States
(12) Patent Application Publication
(10) Pub. No.: US 2009/0018844 A1
(43) Pub. Date: Jan. 15, 2009

(54) Interactive Property Tour

(76) Inventor: John Robert North Baker, South Australia (AU)

Correspondence Address: ALAN HODES;BEYER LAW GROUP, 20450 STEVENS CREEK BLVD, SUITE 200, CUPERTINO, CA, 95014, US

(21) Appl. No.: 10/524,677

(22) PCT Filed: May 16, 2003
(86) PCT No.: PCT/AU2003/001043

§ 371 Date: Jan. 29, 2007

(30) Foreign Application Priority Data
Aug. 15, 2002 (AU) 2002951345

(51) Int. Cl. G06Q 99/00

(52) U.S. Cl. 705/1

(57) ABSTRACT

A system for creating a web based tour for an item of interest characterised in that it includes the steps of:
establishing a tour identity;
associating one or more reference images with the tour identity;
positioning one or more reference icons on one or more of said reference images, each of said reference icons being associated with a further reference image;
and wherein a position of each of said reference icons is selected to provide information relating to said further reference image

### FIELD OF THE INVENTION

The present invention relates to a system for providing that enables businesses to create interactive web images of their products including optional information. The system of the invention is readily adapted to use in variety of industries.

### BACKGROUND OF THE INVENTION

The global computer network, known in many countries as the Internet, has evolved into an effective medium for companies to advertise their products and services; for consumers to view information regarding products and services; and further, for Customers to purchase products and services online.

One industry that has readily seen the advantage of the Internet and incorporated the Internet into its business marketing is the real estate industry. The present invention will be described with reference to its use as a marketing tool for real estate but it must be emphasized that the techniques of the invention are applicable to all businesses that use the internet to market their products and services.

The traditional system for the advertising and purchase of real estate is through a real estate agent who provides details of properties available including floor plans and interior images. Many real estate companies now transfer this information to the Internet. Thus, for each property a collage of still images is provided, perhaps with a floor plan and, in some cases with a 360° virtual tour—in other words an electronic version of a traditional sales brochure is produced. The prospective purchaser has to guess the position from which the pictures are taken and has little information concerning the neighbourhood of the property. Inevitably, therefore, the purchaser is required to visit a substantial number of properties in order to make a comparison and a final selection. This is time consuming and frustrating for both the purchaser and the selling/letting agent.

A web based sales display that allows the addition of information to images and allows the addition geographical information concerning products and services is therefore desirable.

Real estate agents are, of course, skilled in their own field of business and rarely would such business people have the skills and other resources necessary for the creation of the web based information. Accordingly, the task of preparation of the internet site is typically outsourced to a Supplier organisation. This of course comes at a cost that adds to the overhead of the business.

A system that allows relatively inexperienced people to create their own web based sales display is thus desirable.

It is to this situation that the present invention is addressed.

### SUMMARY OF THE INVENTION

Therefore in one form of the invention there is proposed a system for creating a web based tour for an item of interest characterised in that it includes the steps of:
establishing a tour identity;
associating one or more reference images with the tour identity;
positioning one or more reference icons on one or more of said reference images, each of said reference icons being associated with a further reference image;
and wherein a position of each of said reference icons is selected to provide information relating to said further reference image.

Preferably, the tour identity optionally has associated therewith a tour description. Similarly, it is preferable, if said reference images has an associated image description.

In one form of the invention, the reference image and a respective associated image description collectively form page and wherein said tour consists of a plurality of pages collected together as a list of pages.

Preferably, each page is prepared according to a template selected from a number of predetermined template styles.

Preferably, the reference images are stored on one or more remote host servers.

Preferably, at least one of the reference images is a map. The map images can be obtained from a map image database held on a remote server

In a preferred from of the invention, at least one reference image is a plan. For example, in the case where the tour consists of a tour of a property the plan represents a floor plan of the property in question.

Preferably, the reference icons serve to provide information regarding said further reference image associated therewith.

In a further aspect the present invention is characterized by a web based tour for an item of interest characterised in that it includes
a tour identity having a respective tour description;
a plurality of pages forming said tour, each page consisting of one or more reference images associated with the tour each reference having an associated image description;
one or more reference icons positioned on one or more of said reference images, each of said reference icons being associated with a further reference image;
and wherein a position of each of said reference icons is selected to provide information relating to said further reference image.

Preferably, said item of interest is a property and at least one reference image is a plan of said property and wherein reference icons positioned on said plan are associated with reference images provide an indication of a position and direction from which said reference image was obtained and wherein at least one reference image represents a map and includes thereon a reference icon that provides an indication of a position of the property on the map

The system of the invention thus provides the ability to have easily constructed web page tours with each tour containing multiple reference images (such as maps, floor plans, photos, etc) with multiple direction icons linked to photos on each reference image. The tours can be constructed without any detailed web page technical knowledge being needed.

### BRIEF DESCRIPTION OF THE DRAWINGS

The accompanying drawings, which are incorporated in and constitute a part of this specification, illustrate several implementations of the invention and, together with the description, serve to explain the advantages and principles of the invention. In the drawings,

FIG. 1 represents schematically the process of tour construction in the present invention in the form of a flow diagram;

FIG. 2 represents schematically a flow diagram showing in outline detail the system of the present invention;

FIG. 3 illustrates a tour display screen as viewed by prospective purchasers;

FIG. 4 illustrates a tours screen;

FIG. 5 shows an Edit Tour screen used in the construction of a tour;

FIG. 6 shows a List of Pages screen for a specific tour;

FIG. 7 shows an Edit Page screen for a specific tour

FIG. 8 represents a first view of an Edit Page Icons screen;

FIG. 9 represents a second view of the Edit Page Icons screen shown in FIG. 8;

FIG. 10 shows a first File Upload screen;

FIG. 11 shows a Map Link screen;

FIG. 12 shows a Find map screen;

FIG. 13 shows a second File Upload screen;

FIG. 14 illustrates a Finalise tour screen;

FIG. 15 is an Edit Banner screen; and

FIG. 16 is a Change details screen.

### DESCRIPTION OF THE PREFERRED EMBODIMENTS

The following detailed description of the invention refers to the accompanying drawings. Although the description includes exemplary embodiments, other embodiments are possible, and changes may be made to the embodiments described without departing from the spirit and scope of the invention. Wherever possible, the same reference numbers will be used throughout the drawings and the following description to refer to the same and like parts.

The invention will be described with reference to its use in connection with its use by real estate agents, in this context described as a Customer, in the establishment of a number of web based tours for properties they are currently marketing to their own clients. The Customers are able to create web pages consisting of plans with icons linked to pictures. Provision exists for the Customer's own web page to contain a link to the relevant proactive tour so that a client can browse the tour and select the pictures that they wish to view. The item of interest in this case is thus a property.

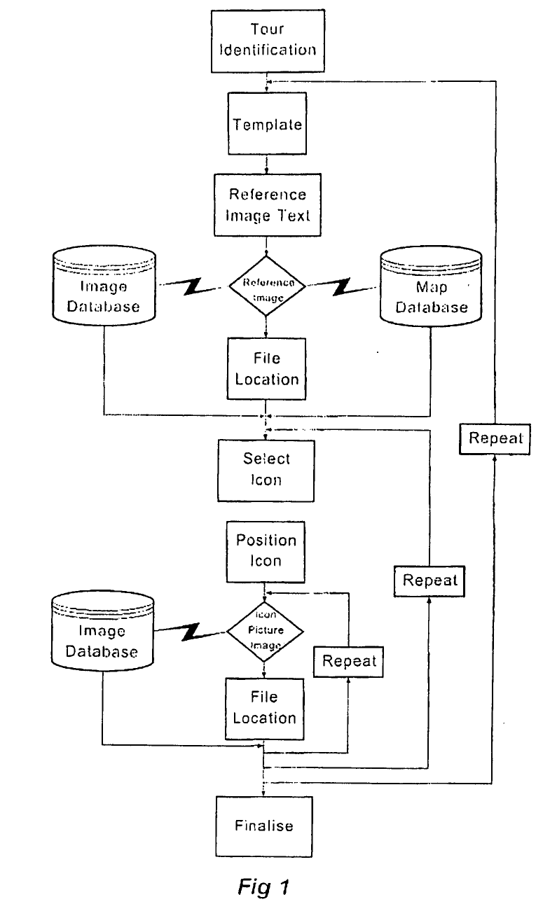

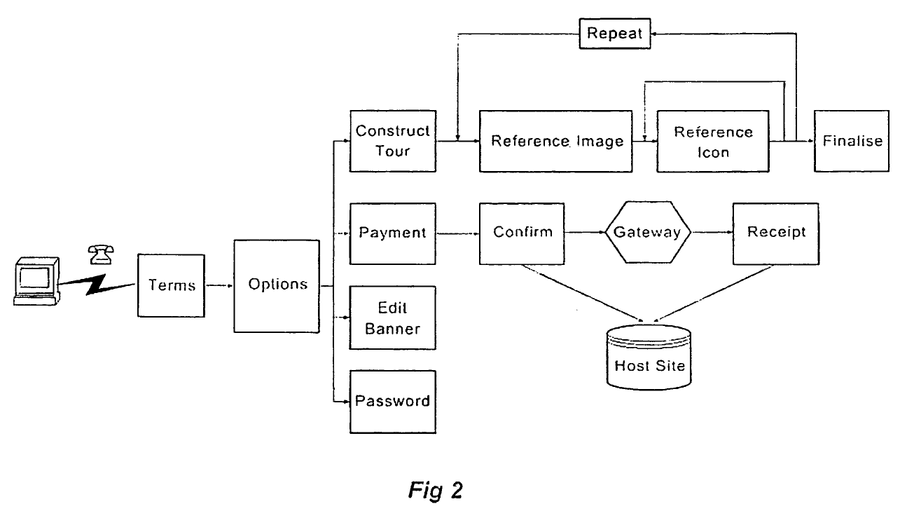

An overview of the processes of the invention, and the discrete steps involved can be seen in FIGS. 1 and 2. Reference will be made throughout the following description to the various steps highlighted in FIG. 1 in particular. FIG. 1 gives a schematic of the process of creation of a tour. The process of tour creation will also be described in detail in the following description.

FIG. 1 presents schematically an overview of the tour creation process. For each tour, a Customer enters text describing the tour and provides the Customer contact details if appropriate (Tour Identification). The Customer then creates the list pf pages and the pages that constitute the tour. Each page has a number of reference images. The tour can thus have multiple reference images where the reference image can be an image of a map, a floor plan, or a photo depicting an item associated with the tour. For each reference image, the Customer provides some text which describes the image to the person viewing the tour. In addition, they select a template, which best suits, the orientation of the reference image (e.g. floor plan) to be used and whether one or two icon images are to be used. The system validates the image provided to ensure that it conforms to the permitted file types and checks that the image file size is not exceeded. If there are no errors, the image is uploaded to the system. As is shown graphically in the figure the images are stored in an Image database, typically on a host server. Maps are also stored in a database. However, this is a separate database from the image database and, in fact is a commercially maintained street map database accessed under license. This gives the Customer the opportunity to include very specific information relating to the product or item on display.

Once the reference image has been successfully loaded, the system provides for a number of icons to be placed onto the reference image at the required location. The system provides a number of icons for the Customer to select the best icon that matches their requirements. The icons available include direction icons to infer to the person viewing the tour the direction that the associated image is being viewed from, together with a panoramic icon, a 360° icon and a map location icon. For each icon, the Customer selects the appropriate icon and places it at the position on the reference image. Then they upload an image (or images) to be associated with that icon. After an icon is selected, the Customer drags and drops the icon onto the reference image at the location where the associated image is being viewed from and then uploads the image that they want connected to the icon. The system performs similar file type and file size validation checks to those performed on the reference image as described above. If there are no errors in the image, the image is uploaded to the system. The system provides for the Customer to upload two images for an icon if necessary. This process is repeated for each icon required to be placed on the reference image. When no more icons are required on a reference image, the Customer can construct another reference image and repeat the above processing.

When the construction of the tour has been completed, the system validates the tour to ensure that the tour is logically complete (e.g. all reference image icons have associated pictures) and provides the necessary HTTP code to link from a Customer's own web page to the constructed tour or the HTTP link for a Customer to insert in their document as a URL or use as required. In addition, the Customer can preview the web page to check how the tour would be viewed on the web and edit the tour if any changes need to be made.

The Customer can tailor their web page banner, which is shown on each of the web pages viewed by a Customer's Client

FIG. 2 provides an over view of the whole process. The Customer accesses the system through an Internet connection and firstly has to agree to standard terms and conditions. Options are provided to the Customer, the Construct Tour option being as outlined above. There are also financial options and other options that allow the customer to edit the appearance of the banner accompanying a constructed tour to customise this to their own requirements.

The system of the invention permits Customers to:
Customise the banner that they wish a browser to see on the proactive tour web page—that is the Customer's own brand banner will be seen by the client
Construct and maintain their proactive tours
Preview the tour as it would appear on the web
Use the link to the proactive tour on the Customer's own web page or as an URL if required
Purchase additional tours online
Maintain their Customer details
Delete expired tours or tours no longer required
Change their system access password

All text in italics relates to specific text, which appears on a screen, eg Next button refers to a button on a screen, which has the caption of “Next”.

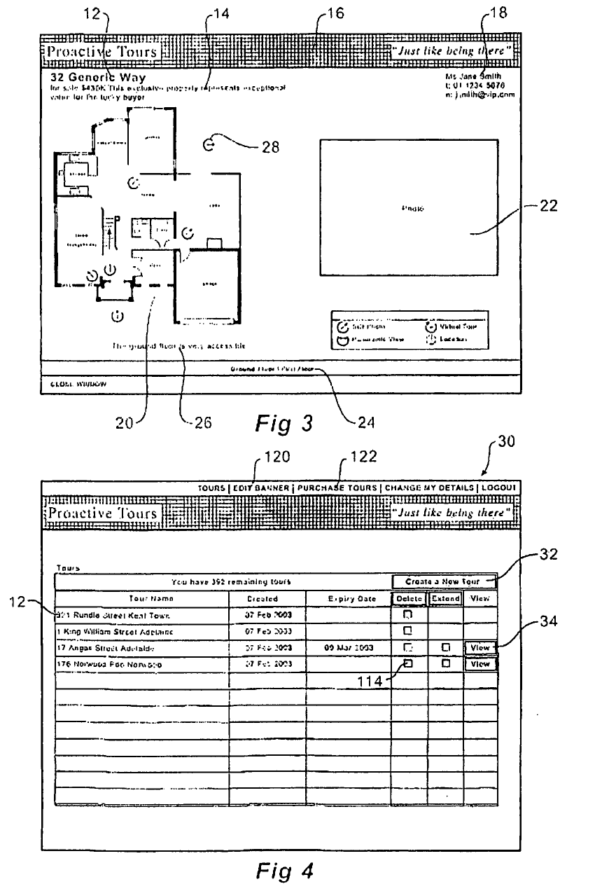

FIG. 3 illustrates a screen showing how a final Tour Display screen 10 would appear in a browser and identifies the different parts of a completed tour. The Tour Display screen 10, as viewed through a web browser includes a tour name 12, a tour description 14, a banner 16, tour contact details 18, an uploaded plan 20 and one or more uploaded pictures 22, a page name 24, page description 26 and one or more icons 28. Importantly the icons 28 may be superimposed on both uploaded plans 20 and uploaded pictures 22.

The invention will now be described with reference to the creation and editing of a tour as shown in FIG. 3. The tour is created directly by the Customer by interaction with the Supplier web site.

### Login

A system administrator is responsible for the management of the Supplier system. The system administrator assigns each new Customer a unique Username and Password. The system administrator is also responsible for the management of a pricing structure for the payment of tours by Customers.

The Customer accesses the Tours system by using the “login link” from the Supplier web site. This will display the login information where the Customer will enter the Username and Password supplied by the System Administrator. The password provided is case sensitive and needs to be entered exactly as advised by the System Administrator.

The system permits multiple Customers to be logged in under the same User Name at the same time.

If the Customer has forgotten their password, and they try to log in more than 3 times, the system will de-activate the Customer and it will be necessary to contact the System Administrator to get their password reset.

The Customer is able to change their password if required.

### Tours

After a Customer has successfully logged in, a tours screen 30 appears showing a list of any current tours 12. FIG. 4 illustrates the tours screen 30. The tours screen includes a list of all tours 12 that the Customer has created, or is in the process of creating. The list of tours 12 is sorted with the tours under construction at the top of the list with the remaining tours 12 sorted into expiry date order with the oldest tours 12 sorting to the top of the list.

The tours screen 30 provides the Customer with several options. The Customer can construct a new tour can be constructed using the Create a New Tour button 32; or select an existing tour to maintain by clicking the required Tour Name 12. Similarly, an existing tour can be previewed by clicking the View button 34 at the right hand end of the row of the tour required.

### Construct Tour

A Tour is constructed by following a sequence of steps:
Input the tour text and tour contact details
Input the text details relating to each tour page and nominate a template to be used for that page (a tour can have multiple pages)
Upload a plan for each page
Position icons on the plan and upload or link pictures associated with each icon.
Finalise a tour. This step permits the tour to be accessed by a browser and provides the necessary HTML code or URL to link the tour from a Customer's own web site.
The system also provides for the User to maintain the tour after the tour has been finalised.

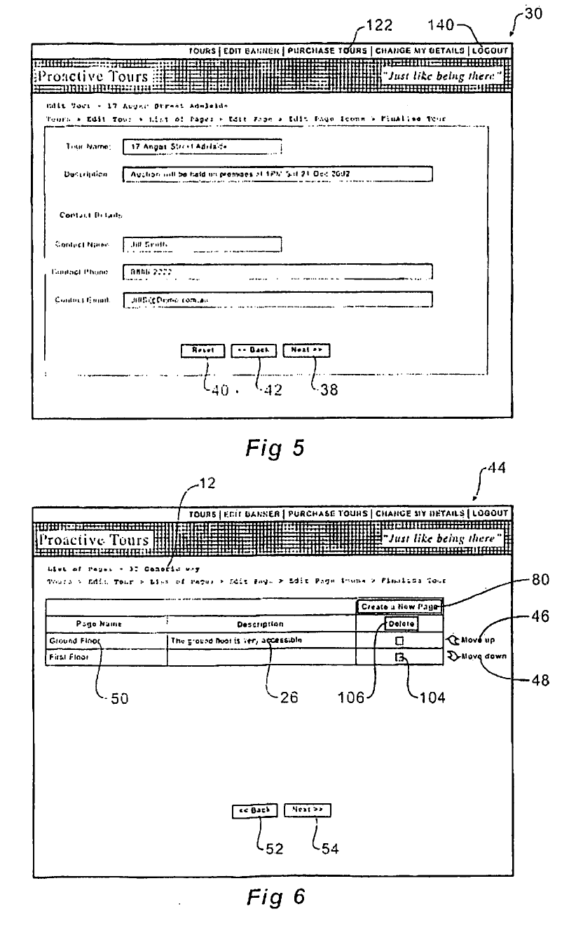

When the Customer clicks on the Create a New Tour button on the Tours screen 30, a new Edit Tour screen 36 is displayed as shown in FIG. 5. The Edit Tour screen 36 has a number of text boxes that allow the Customer to input data specific to the tour under creation. The Customer selects and inputs a Tour Name 12, and a Tour Description 14. In the example shown, the Tour Name 12 is “17 Angas Street Adelaide” and the Tour Description 14 is “Auction will be held on premises at 1 pm Sat 21 Dec. 2002”. It can be seen that Customers have the freedom to select any Tour name and Description that is relevant to their product. Thus, for example, the tour may be a tour of a tourist facility or a motor vehicle or a university and the tour description would thus highlight perhaps the location, model or department as preferred by the Customer. In each case, the basic process is the same.

The Customer also has the opportunity to input contact details 16 that appear on the Tour display screen 10.

When the User clicks the Next 38 button, the system displays a message to confirm the Tour Name 12 entered. If the User confirms that the Tour Name 12 is correct, the tour record is created and one of the Customer's tour credits is used. The tour expiry date is not set until the tour has been finalised.

The Reset 40 button will reset any data (except the Tour Name field after the initial Tour Name confirmation) that has been entered back to the values before the change. Any changes made will not be saved. Using the Back 42 button or the Next 38 button will save any changes made to that screen. Having created the identity of the tour it is now necessary ti create the body of the tour in the form of the images and data that together make the tour.

### List of Pages

After the User confirms the tour name 12, the system will display a List of Pages screen 44 as shown in FIG. 6. Each tour can consist of multiple web pages. The List of Pages screen 44 permits the Customer to construct and maintain each tour page.

The Tour Name 12 is listed together with a list 50 of the pages that have been created for the tour. When the tour is first constructed, there are no tour pages listed. Use the Create a New Page button to construct a page to be used in the tour. This will display the Edit Page screen.

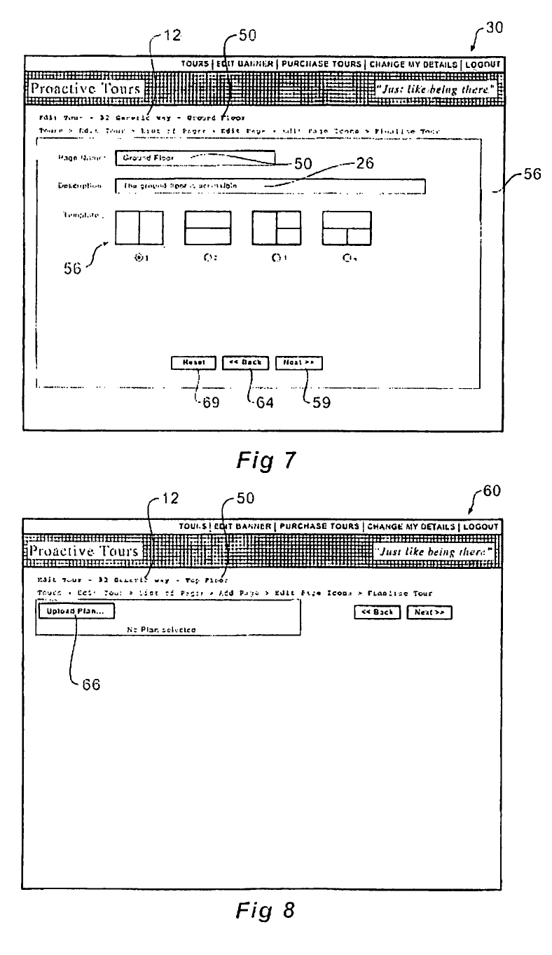

If the tour consists of more than one tour page, the system displays Move Up and Move Down buttons 46, 48 on the right hand side of the screen. The Move Up and Move Down buttons 46, 48 are used to change the sequence of the tour pages when they are displayed by a browser. To move a page the Customer selects the page, which needs to be moved by clicking on the row (not the Page Name) and then using the appropriate direction button. Repeat clicking the direction button until the tour page is in the position required. Using the Next 54 button will save any changes made to the List of Pages screen 44 and will bring up the Edit Page screen 56 as shown in FIG. 7. In the example under consideration, five pages can be constructed for each tour. However, this is an arbitrarily selected number considered appropriate tot eh business environment for real estate sales. Other industries may require more pages.

### Edit Page

The Edit Page screen 56 permits the page text and the template to be used for the page to be entered. The Tour Name 12 is shown at the top of the screen. The Page Name 50 and the Page description 26 are entered and edited at this point. The Page Name is a mandatory field and data must be entered. The text entered for the Page Name 50 will be displayed by a browser as the caption on the link to select this page for viewing.

The Page Description field 26 is an optional field.

On the screen below the Page name and page description fields is the template selection field 58. The Customer has to nominate a template to be used. The template 58 defines how a page appears when viewed by a browser. The templates 58 depict the layout to be used for each tour page with the tour plan showing on the left or the top of the screen and the images on the right or the bottom. It is mandatory that a template be selected. Once a template has been selected and saved, it cannot be changed.

Depending upon the template 58 selected, the tour plan is shown either on the left hand side or on the top of the tour page screen. The template selected also affects how pictures would be displayed by a browser. Pictures either would be on the right hand side or on the bottom of the tour depending upon the template selected. Those templates that show two pictures permit two pictures to be uploaded for icons used on that plan although only one picture would be displayed at a time in a browser.

The Tourn page 10 shown in FIG. 1 is an example of template version 1. A tour plan 20 is shown on the left hand side and a tour picture 22 on the right hand side.

When the Customer left clicks the Next button 59, the system displays the Edit Page Icons screen 60 shown in figure

The Reset button 62 will reset back to the values before editing and any changes made are not saved. Using the Back 64 button or the Next button 59 will save any changes made to that screen.

Edit Page Icons

The Edit Page Icons screen 60 permits the plan 20, the plan icons 28 and the pictures required for the page to be input. When the Customer enters the screen 60 the screen is as shown in FIG. 8.

The Tour Name 12 and the Page Name 50 are shown at the top of the screen 60.

An Upload Plan button 66 is used to input a plan 20 or locate a map to be used for the page. This would display the File Upload screen 68, see FIG. 10. A description of the File Upload screen 68 is found herein below.

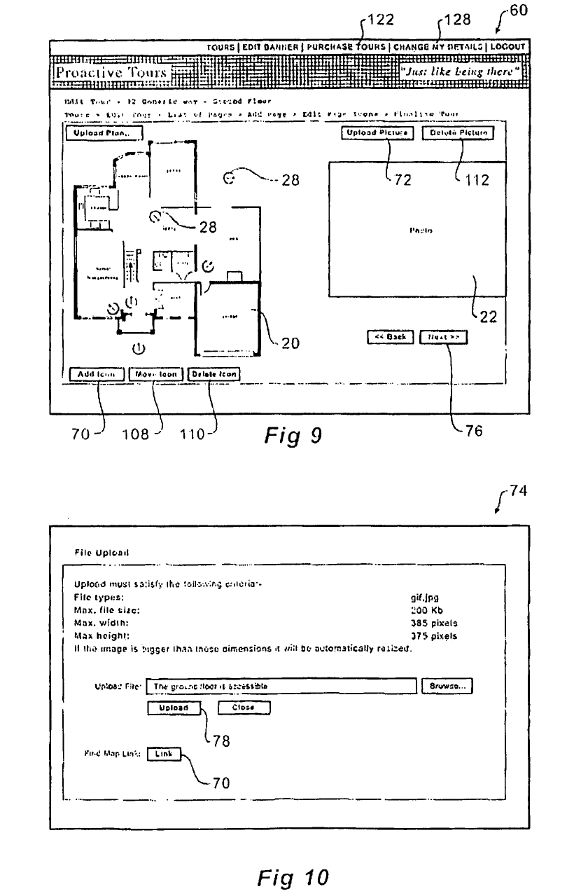

After the plan or map 20 has been uploaded, it is displayed on the Edit Page Icons screen 60 and an Add Icon button 70 becomes visible as shown in FIG. 9. The Add Icon button 70 displays the icons 28 available to be used on the plan 20. In the embodiment of the invention under consideration, there are eight direction icons available to the customer for use. The icons 28 may indicate, for example, the position from which an image is taken, a panoramic icon, a 360° virtual tour icon and a red “L” for a Location icon for use on a map. An icon 28 is selected by clicking the icon 28 and then moving the pointer to the position on the plan where the icon is required, click at that position and the selected icon will be placed at that position. The icon 28 is displayed in red on the plan at the location required. An icon 28 on position on the plan may be repositioned from the maintain tour process described later.

Having positioned an icon 28 on the plan 20 it is now necessary to associate an image with the icon. The Upload Picture feature is used to achieve this. Activating the Upload Picture button 72 opens the File Upload screen 74, see FIG. 10. Once an image has been uploaded File Upload screen 74 closes and on returning to the Edit Page Icons screen 60, the picture uploaded 22 will be displayed. If the template 58 selected in the Edit Page 56 screen permits two pictures for the page, then two separate images in two separate files may be selected for uploading and the upload step is repeated to upload the second picture. If the incorrect picture has been associated with an icon, the correct picture can be associated with the icon by using the Upload Picture button again.

If additional pages are required for the tour, use the Back button 78 to return to the List of Pages screen 44 and then use the Create a New Page button 80 to construct another new page following the steps outlined above.

In this embodiment, a customer may use up to 10 icons to be used on a plan.

When all pictures have been uploaded the tour creation is completed, and the Customer selects the Next button 76 to progress to the Finalise Tour screen. The completed tour page after construction will appear similar to FIG. 9:

Upload Plan/Map

The File Upload screen 74, shown in FIG. 10 is used to upload a plan 20 or to access the “Wherels” web site to obtain an appropriate map to be used on a tour page. The system of the invention is able to link to images held on a number of servers. This varies with current systems in which all data is hosted in a single location. Using the example of real estate agents, typically the location of a property is very important and it is desirable to provide potential purchasers with guidance as to the locality of a property. However, the creation and maintenance of a map database is beyond the scope of existing Internet property-listing services. The present invention circumvents this difficult by allowing the Customer to incorporate elements from commercially available and professionally maintained map databases. Further, as the maps used by customer sin the creation of a tour are simply an alternative form of image, this provides the customer with the opportunity to use Page icons in connection with a map to provide further information.

Page plans 20 are uploaded to the Host server. Maps however, are linked to the “Wherels” site on the web. The File Upload screen 74 appears as FIG. 10.

Plan images in .jpg or .gif file types can be uploaded.

At the top of the screen, the file size and pixel limits for the image are displayed. The pixel limits for a plan are determined from the template selected for the tour page, which in turn determines the space available on the page when the tour is being viewed in a browser. When a plan is being uploaded, the system checks the size of the plan to ensure that the image being provided does not exceed the tour file size limits. The File Upload screen 74 also displays the image height and width in pixels to indicate the size of the plan image that would be used by the system.

To upload a plan, use the Browse button to set the path and file name of the image to be uploaded. For example, images may be on a hard drive, on a floppy disk or be loaded directly from a digital camera. The Upload button 78 serves to load the image to the Host server. If the upload is successful, the Close button returns the Customer to the Edit Page Icons 60 screen where the uploaded image is then displayed. If any errors occurred during the upload, they are displayed and, in some circumstances, it will be necessary to make any corrections to the file size if it is outside the maximum values set by the Host system using any image processing software available.

It is also possible to locate and use a map on a tour page. The map is obtained from data located on the commercially available site.

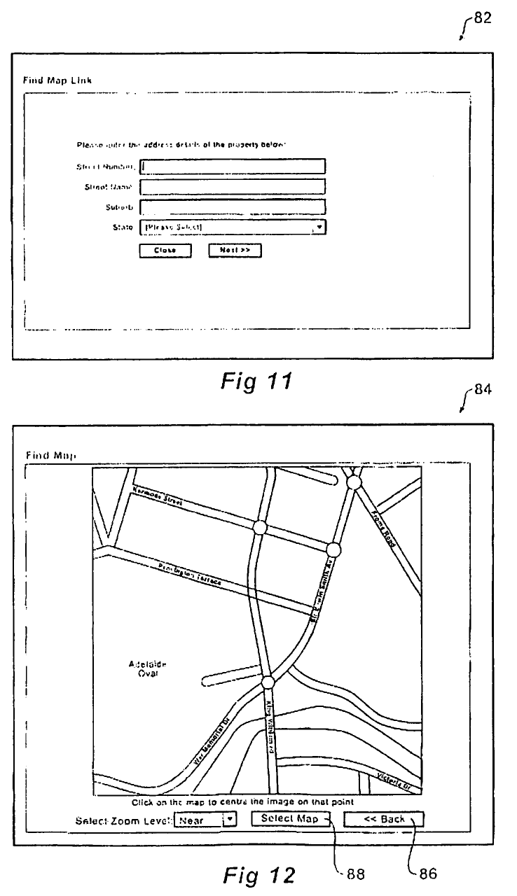

The Link button 80 displays the Find Map Link screen 82, which thereby allows the Customer to select the map required. FIG. 11 shows the Find Map Link screen 82. data representing the address sought is entered as street number, street name, suburb and State. These fields are mandatory fields for the location required for the map and then use the Next button. In some cases, this will result in a map being displayed. However, if the address results in more than one possible map, the system will display a list of potential addresses that match the address criteria entered. These addresses are displayed in the Find Map Link screen 82. The Customer has the opportunity to select the required address, or if no address is correct, to use the back button to return to the Find Map Link screen 82, would be displayed as follows:

When an address has been selected it will appear in the Find map screen 84 as shown in FIG. 12.

The size of the map can be adjusted to five levels of zoom and these are available from the drop down list in the Select Zoom Level field. This will return a new map at the selected zoom level. The original map returned defaults to the near zoom level.

The map can also be re-positioned if necessary. This is achieved by clicking on the displayed map at the point where the new centre point of the map is required. This will return a new map with a revised centre. The map can be re-positioned at any zoom level.

The Back button 86 returns to the Find Map Link screen 82 to check or change the address details.

The Select Map button 88 will return to the Edit Page Icons screen 60 where the selected map would be displayed ready to positioning icons on.

Upload Picture

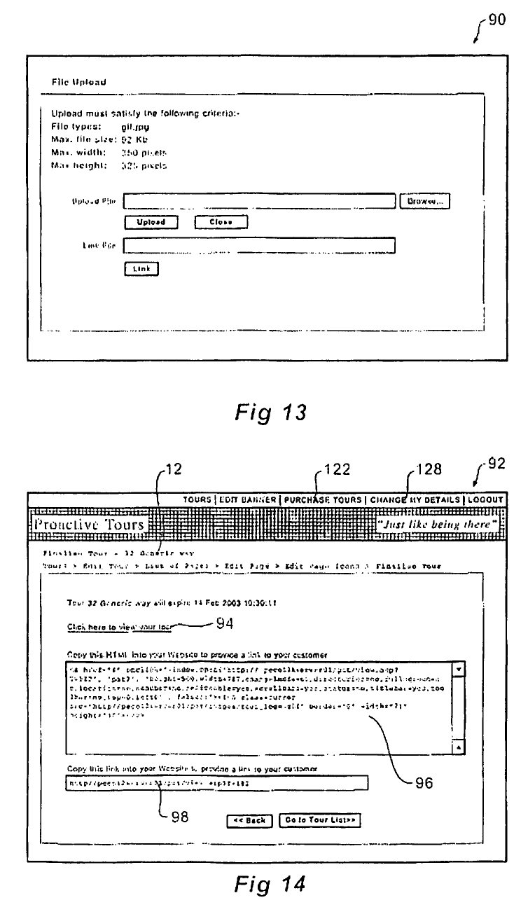

An alternative File Upload screen 90 is shown in FIG. 13. As can be seen with a comparison of FIG. 10 no map link facility appears on this screen. The screen 90 is used to upload the Picture to be used on a tour page. The system checks the size of the picture to ensure that the image being provided does not exceed the tour file size limits .jpg and .gif file types can be uploaded.

At the top of the screen, the file size and pixel limits for the image are displayed. The pixel limits for an image are set from the template selected for the tour page, which in turn determines the space available on the page when the tour is being viewed in a browser.

Page pictures can be uploaded to the Host server, or linked to a server on the web.

To upload a picture image, use the Browse button to set the path and file name of the image to be uploaded. Then use the Upload button to load the image to the Proactive Tours server. If the upload is successful, use the Close button to return to the Edit Page Icons screen where the uploaded image will be displayed. If any errors occur during the upload, they are displayed and it will be necessary to make any corrections to the image file size outside the maximum set by the Proactive Tours system using any image processing software available.

To link a picture already on a web server, type in the Link File field the URL location where the picture required is located and use the Link button. If successful, the system will return to the Edit Page Icons screen 60 where the linked picture would be displayed. Any errors that occur during the link processing will be displayed for our information.

The Customer has now created a tour including a plan 20 having icons positioned thereon to assist those viewing the site to identify where the images associated with the plan are taken. Further, the potential purchaser can easily comprehend the nature of the location of the property by considering the linked map file.

Finalise Tour

When the tour pages required for a tour have been constructed following the above method, the Finalise Tour screen 92 is displayed as shown in FIG. 14. The Finalise Tours screen 92 performs the validation on the tour that has been constructed to ensure that the tour is logically complete, that is, that all icons have associated pictures. If the tour is valid, the HTML code needed to link from a Customer's own web page to the proactive tour is provided as well as a link to the tour which can be pasted into any text.

In the Finalise Tour screen 92, the tour name 12 is identified at the top of the screen.

If the tour has any logic errors in its construction, the system will identify these for correction before the tour can be finalised. If the User clicks on the error, the system will take the Customer to the screen where the error has been detected so it can be corrected.

If the tour is valid, the tour is assigned an expiry date and this is displayed at the top of the screen. The tour expiry date is determined from the default period for a tour as determined by Systems Administrators.

The Customer can preview the tour that they have constructed by clicking on the “Click here to view your Tour” text 94. This will take the Customer to the web page where the tour can be viewed in a browser to verify its functionality.

The HTML code 96 needed for the Tour icon to link from a Customer's own web page to the Tour on the host web site can be copied and pasted into the web page required. This may need assistance from a person with some skills in HTML coding.

The HTTP link 98 is provided which can be copied and pasted into any text document or into sites that provide for a URL or link on their site.

The advantage of the present invention becomes apparent at this stage. The screens used in the present invention are capable of use by customers with no web page skills and provide an easy to interpret interface for the creation of tours. This compares favourably with prior art devices that require sophisticated software manipulation skills for their operation

Activating the Go To Tour List button 100 takes the use to the Tours screen 30.

Maintain Tour

Once a tour has been finalised, it can still be maintained providing the tour has not expired.

From the Tours screen 30, the Customer selects the Tour Name 12 required by clicking on the Tour Name in the list. To assist Customers in navigating to the required screen within a finalised tour, a breadcrumb at the top of the screen has shows each of the screen names used to construct the tour. The Customer can then use the breadcrumb to go the screen required to view or make changes to the tour. Using the Back or Next buttons on that screen to save changes. If any changes are made to the tour, it is suggested that the User go to the Finalise Tour screen, which would validate the tour to ensure that the tour is still logically correct.

Any text (except the Tour Name) on both the tour or on each tour page can be changed as required.

The maintenance feature can be used to delete a tour page, move an icon 28, delete an icon 28 or delete a page picture.

To Delete a tour page 50, select the List of Pages screen 44, click the check box 104 in the Delete column for the row being deleted, and use the Delete button 106. Multiple pages can be deleted at the one time if required. After confirming the deletion, the system will delete the plan, icons and pictures used for that page(s).

To move an icon 28, select the Edit Page Icons screen 60 and then select the icon 28 that needs to be moved. The icon selected will display in red. Use the Move Icon button 108, select a different icon if necessary, and click the new position where the icon should be.

To delete an icon, select the Edit Page Icons screen 60 and then select the icon 28 that needs to be deleted. The icon selected will display in red. Use the Delete Icon button 110. A confirmation message needs to be accepted before the icon would be deleted. When the icon is deleted, the system will also delete any pictures that had been associated with that icon.

To Delete a picture, select the Edit Page Icons screen 60 and then use the Delete Picture button 112. A confirmation message needs to be accepted before the picture would be deleted.

Delete Tour

A tour can be deleted at any time after it has been created by using the Tours screen 30. Tours 12 which need to be deleted are selected by clicking the appropriate Tour Name check box 114 in the Delete column and then use the Delete button 116. Multiple tours can be deleted at the one time if required. After confirming the deletion, the system will delete the tour from the system. Only those tours visible on the screen will be deleted. The User should also remove any links to the tour to prevent a browser receiving an error when trying to access a deleted tour.

A tour cannot be re-instated after it has been deleted. If the tour were needed again after it had been deleted, it would be necessary to reconstruct the tour using another tour credit.

Extend Tour

When a tour is created, it is available for use until the expiry date, assigned to the tour at the time the tour was finalised. If a tour needs to be used after its expiry date, it can be extended for a further standard period and a new expiry date is assigned to the tour. Extending a tour avoids the need to reconstruct the tour as the old tour is re-used. When a tour is extended, another tour credit is used as though a new tour had been constructed.

A tour can be extended at any time after it has been created by using the Tours screen 30. If the tour has expired, the tour is extended for a further period from the date when the extension was requested. If the tour has not expired, the tour expiry date is extended by a further standard period. Tours that need to be extended are selected by clicking the appropriate Tour Name check box 118 in the Extend column. Only those tours visible on the screen will be extended.

The standard period of extension is determined by Systems Administrators.

It should be noted that expired tours are periodically deleted by the Systems Administrators and a tour can only be extended if the tour has not been deleted. Any links to tour that has expired would result in a browser receiving an error when trying to access the tour.

Preview Tour

A tour can be previewed after it has been finalised by using either the View button 34 alongside the tour on the Tours screen 30 or from the Finalise Tour screen 92 using the link “Click here to view your tour” 94.

Edit Banner

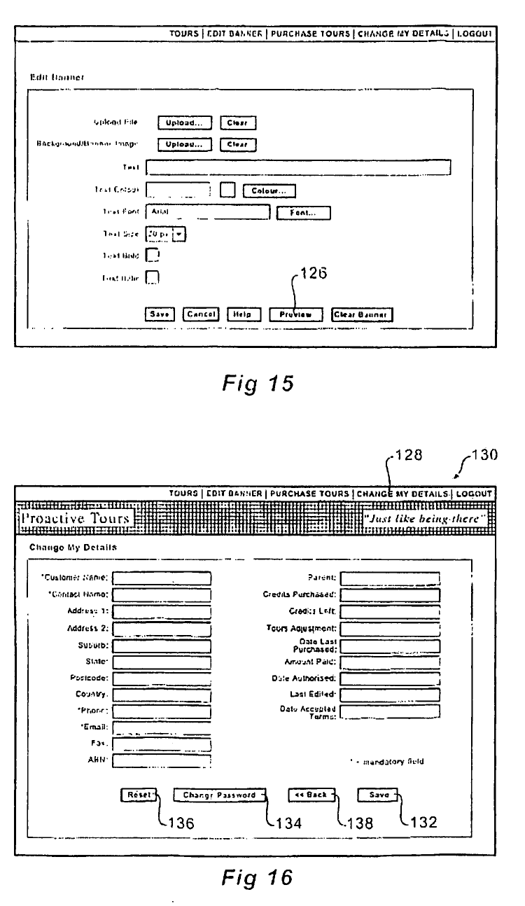

A tour viewed by a browser has a banner at the top of the screen that can be customised to an individual Customer's requirement. The edit banner screen 125, shown in FIG. 15 is accessed using the Edit Banner menu item 120 at the top of the screens.

The system provides for three levels of banner:
A Customer banner
A Customer's Parent Banner
A system default banner

If a Customer's Banner details are present, then they take precedence and would be used when the tour is viewed. If the Customer has not input any banner details, the Customer's Parent's banner would be used if present, otherwise the system default banner would be used.

The banner consists of three components.
A logo (uploaded by Customer)
A background image (uploaded by Customer)
Text (text value, colour, font, size, bold and italic can be set)

These features are set in the Edit banner screen 124 shown in FIG. 15 and the finished result may be viewed using the preview button 126.

Purchase Tours

The system permits the Customer to purchase additional tours online. To access this facility, use the Purchase Tours 122 menu item at the top of the Tours screen. This will normally display a screen to advise the Customer that the information they will be providing is being made over a secure connection:

However, if there is a problem with the security connection, a screen indicating that the Customer needs to make adjustments in their settings for Control Panel—Internet Options—Security appears.

After accepting the Security Alert screen, the system will allow the Customer to make payments. After the number of tours to purchase has been determined, a payment is made using credit card payment. The security of the payment system is ensured by using financial payment software available from recognised financial institutions. The system thus communicates with a financial institution for recording a financial transaction. Once a payment has been accepted by the financial institution the system generates an invoice and receipt for the customer.

Change My Details

The User is able to edit and view their Customer details recorded by the system. To access this information, use the Change My Details 128 menu item at the top of the screen. This will display the Change My Details screen 130 shown in FIG. 16. The Customer has to enter data in a number of mandatory fields—marked with an asterisk for convenience. Other fields are optional. Data is saved by using the Save button 132.

If the User wishes to change their password, use the Change Password 134 button on this screen. The Reset button 136 will reset any data that had been changed back to the values before the change. Any changes made will not be saved.

Using the Back button 138 will not save any changes made.

Log Out

The User can log out of the system by using the Logout menu item at the top of the screen 140.

Further advantages and improvements may be made to the present invention without deviating from its scope. Although the invention has been shown and described in what is conceived to be the most practical and preferred embodiment, it is recognized that departures may be made therefrom within the scope and spirit of the invention. The invention is not to be limited to the details disclosed herein but is to be accorded the full scope of the claims to embrace any and all equivalent devices and apparatus.

In any claims that follow and in the summary of the invention, except where the context requires otherwise due to express language or necessary implication, the word “comprising” is used in the sense of “including”, i.e. the features specified may be associated with further features in various embodiments of the invention.

1. A system for creating a web based tour for an item of interest including the steps of:
establishing a tour identity;
associating one or more reference images with the tour identity;
positioning one or more reference icons on one or more of said reference images, each of said reference icons being associated with a further reference image;
and wherein a position of each of said reference icons is selected to provide information relating to said further reference image.

2. A system for creating a web based tour according to claim 1, wherein said tour identity optionally has associated therewith a tour description.

3. A system for creating a web based tour according to claim 1, wherein each of said reference images optionally has an associated image description.

4. A system for creating a web based tour according to claim 3, including a reference image and a respective associated image description collectively form page and wherein said tour consists of a plurality of pages collected together as a list of pages.

5. A system for creating a web based tour according to claim 4, wherein each page is prepared according to a template selected from a number of predetermined template styles.

6. A system for creating a web based tour according to claim 1, wherein said reference images are stored on one or more remote host servers.

7. A system for creating a web based tour according to claim 1, wherein at least one of said reference images is a map.

8. A system for creating a web based tour according to claim 1, wherein at least one of said reference images is a plan.

9. A system for creating a web based tour according to claim 1, wherein each of said reference icons serves to provide information regarding said further reference image associated therewith.

10. A system for creating a web based tour according to claim 1, wherein said item of interest is real estate.

11-12. (canceled)

13. A system for creating a web based tour for an item of interest including the steps of:
establishing a tour identity;
associating one or more reference images with the tour identity;
positioning one or more reference icons on one or more of said reference images, each of said reference icons being associated with a further reference image;
and wherein a position of each of said reference icons is selected to provide information relating to said further reference image.

14. A system for creating a web based tour according to claim 13, wherein said tour identity optionally has associated therewith a tour description.

15. A system for creating a web based tour according to claim 1, wherein each of said reference images optionally has an associated image description.

16. A system for creating a web based tour according to claim 15, wherein a reference image and a respective associated image description collectively form a page, and wherein said tour consists of a plurality of pages collected together as a list of pages.

17. A system for creating a web based tour according to claim 16, wherein each page is prepared according to a template selected from a number of predetermined template styles.

18. A system for creating a web based tour according to claim 13, wherein said reference images are stored on one or more remote host servers.

19. A system for creating a web based tour according to claim 13, wherein that at least one of said reference images is a map.

20. A system for creating a web based tour according to claim 13, wherein at least one of said reference images is a plan.

21. A system for creating a web based tour according to claim 13, wherein each of said reference icons serve to provide information regarding said further reference image associated therewith.

22. A system for creating a web based tour according to claim 13 wherein said item of interest is real estate.

23. A system for creating a web based tour according to any one of claims 13 to 22, further including the step of:
receiving user input indicating the position of the at least one icon on the at least one reference image, and indicating an association between each icon and the further reference image, and wherein each reference icon is positioned in response to the user input.

24. A system for creating a web based tour according to claim 23, further including the step of:
displaying to the user the at least one reference image, allowing the user to subsequently provide the user input whilst viewing the at least one reference image.

25. A system for creating a web based tour according to claim 23 or 24, wherein the user input indicating the position of an icon is provided by clicking on a part of a displayed image.

26. A system for creating a web based tour according to claim 19, wherein the at least one reference icon is positioned on the map, at least one of the associated further images relates to the item of interest, and the position of the reference icon indicates the position of the item of interest on the map.

27. A method for creating a web based tour for an item of interest including the steps of:
establishing a tour identity;
associating at least one reference image with the tour identity;
positioning at least one reference icon on at least one of said reference images, each of said reference icons being associated with a further reference image; and
wherein a position of each of said reference icons is selected to provide information relating to said further reference image.

28. A method for creating a web based tour according to claim 27, wherein said tour identity optionally has associated therewith a tour description.

29. A method for creating a web based tour according to claim 27, wherein each of said reference images optionally has an associated image description.

30. A method for creating a web based tour according to claim 29, wherein a reference image and a respective associated image description collectively form a page and wherein said tour consists of a plurality of pages collected together as a list of pages.

31. A method for creating a web based tour according to claim 30, wherein each page is prepared according to a template selected from a number of predetermined template styles.

32. A method for creating a web based tour according to claim 27, wherein said reference images are stored on one or more remote host servers.

33. A method for creating a web based tour according to claim 27, wherein at least one of said reference images is a map.

34. A method for creating a web based tour according to claim 2, wherein at least one of said reference images is a plan.

35. A method for creating a web based tour according to claim 27, wherein each of said reference icons serve to provide information regarding said further reference image associated therewith.

36. A method for creating a web based tour according to claim 27, wherein said item of interest is real estate.

37. A method for creating a web based tour according to any one of claims 27 to 36, further including the step of:
receiving user input indicating the position of the at least one icon on the at least one reference image, and indicating an association between each icon and the further reference image, and wherein each reference icon is positioned in response to the user input.

38. A method for creating a web based tour according to claim 37, further including the step of:
displaying to the user the at least one reference image, allowing the user to subsequently provide the user input whilst viewing the at least one reference image.

39. A method for creating a web based tour according to claim 24 or 37, wherein the user input indicating the position of an icon is provided by clicking on a part of a displayed image.

40. A method for creating a web based tour according to claim 37, wherein the at least one reference icon is positioned on the map, at least one of the associated further images relates to the item of interest, and the position of the reference icon indicates the position of the item of interest on the map.

41. A method for creating a web based tour, the tour having at least one image and at least one reference icon, each icon to be associated with at least one of said image, the method including the step of:
receiving user input indicating the position of the at least one icon on a first image and an association between said icon and at least one further image of said images wherein the position of the each icon on the first image provides information about the respective associated further image.

42. A method for creating a web based tour according to claim 41, further including:
configuring the tour to display the at least one icon on the first image, at the position indicated by the user input.

43. A method for creating a web based tour according to claim 42, further including:
displaying the tour with the at least one icon displayed on the first image, at the position indicated by the user input.

44. A method for creating a web based tour according to claim 42 or 43, wherein the configuring step includes providing a link between each reference icon and its associated further image.

45. A system for creating a web based tour, the tour having at least one image and at least one reference icon, each icon to be associated with at least one image, the system including:
a receiver to receive user input indicting the position of the at least one icon on first image and an association between said icon and at least one further image of said images wherein the position of the each icon on the first image provides information about a respective associated further image; and a tour creation element to create a web based tour configured to display the at least one icon on the first image, at the position indicted by the user input.

46. A computer readable medium, encoded with data representing a computer program, which can be used to direct a programmable device to perform the system of any one of claims 13 to 26 and 45.

47. A computer readable medium, encoded with data representing a computer program, which can be used to direct a programmable device to perform the method of any one of claims 27 to 44.

48. A computer program element comprising a computer program code means to make a programmable device execute the system of any one of claims 13 to 26 and 45.

49. A computer program element comprising a computer program code means to make a programmable device execute the method of any one of claims 27 to 44.
